(19) United States
(12) Patent Application Publication
(10) Pub. No.: US 2007/0043934 A1
(43) Pub. Date: Feb. 22, 2007

(54) Early misprediction recovery through periodic checkpoints

(75) Inventors: Avinash Sodani, Portland, OR (US); James Hadley, Portland, OR (US)

Correspondence Address: CAVEN & AGHEVLI;c/o INTELLEVATE, P.O. BOX 52050, MINNEAPOLIS, MN, 55402, US

(73) Assignee: Intel Corporation

(21) Appl. No.: 11/208,924

(22) Filed: Aug. 22, 2005

(51) Int. Cl. G06F 9/44

(52) U.S. Cl. 712/228

(57) ABSTRACT

Methods and apparatus to provide misprediction recovery through periodic checkpoint are described. In one embodiment, a renamer unit (e.g., within a processor core) recovers a register alias table (RAT) to a state immediately preceding a misprediction.

### BACKGROUND

The present disclosure generally relates to the field of computing. More particularly, an embodiment of the invention relates to misprediction recovery through periodic checkpoints.

To improve performance, some processors utilize speculative processing which attempts to predict the future course of an executing program to speed its execution, for example, by employing parallelism. The predictions may or may not be correct. When they are correct, a program may execute in less time than when non-speculative processing is employed. When a prediction is incorrect, however, the machine has to recover its state to a point prior to the misprediction. One form of recovery that takes place after a branch misprediction is branch recovery. Generally, branch recovery attempts to recover a machine state after branch mispredictions so that the machine may resume operating on “uops” (micro-operations) from the correct path.

Moreover, one state that is recovered is a register rename table (or a register alias table (RAT)). A RAT may be used to map logical registers (such as those identified by operands of software instructions) to corresponding physical registers.

The approaches used in current processors to recover the RAT state are either too slow, that is there is a long wait before the RAT state is recovered and before the execution of the program can resume, or are too expensive in terms of hardware to implement. For example, in some of the current microarchitectures, machine state is recovered when the mispredicted branch “retires”. Retire or retirement is a stage in the processor pipeline that is usually the last stage that uops pass through during their execution by a processor. Generally, a uop can retire only after it has completed execution and all uops that were fetched into the processor before it have retired. At retirement, uops from a mispredicted path (false uops) remain in the machine. Renaming tables (or RATs) are reset to retired values and allocated resources for false uops are freed. After this, the new uops are allowed to enter into the machine. This mechanism has at least one performance downside in that the machine may not start executing uops from the correct path until the mispredicted branch retires, which may be a relatively long time if the branch retirement is significantly delayed, for example, due to an older but unrelated cache miss or other long latency operations.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates a block diagram of portions of a processor core, according to an embodiment of the invention.

FIG. 2 illustrates a block diagram of an embodiment of a decode unit.

FIG. 3A illustrates a sample sequence of uops and corresponding identifiers assigned to each uop, according to an embodiment.

FIG. 3B illustrates a sample uop information list, according to an embodiment.

FIG. 3C illustrates register alias table states, according to various embodiments.

FIGS. 4A, 4B, and 5 illustrate sample values according to various embodiments.

FIG. 6 illustrates a flow diagram of an embodiment of a method to provide early misprediction recovery through periodic checkpoints.

FIGS. 7 and 8 illustrate block diagrams of computing systems in accordance with various embodiments of the invention.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention.

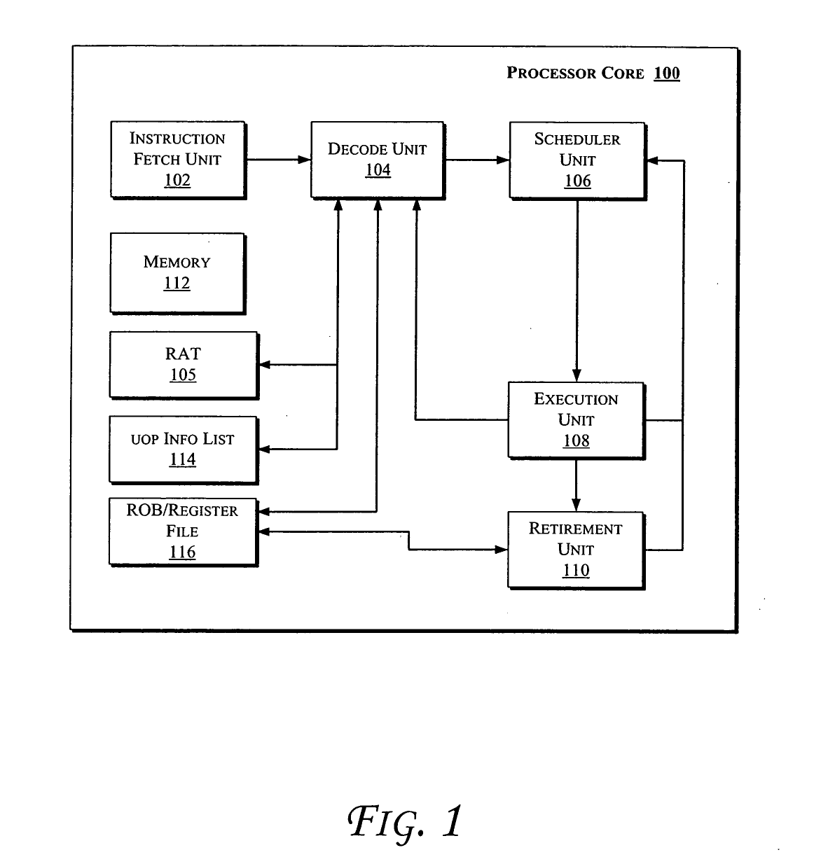

Techniques discussed herein with respect to various embodiments may efficiently recover a RAT state after a misprediction (or any other form of program execution disruption where program execution is to be redirected to a different point in a program) in a processing element, such as the processor core shown in FIG. 1. More particularly, FIG. 1 illustrates a block diagram of portions of a processor core 100, according to an embodiment of the invention. In one embodiment, the arrows shown in FIG. 1 indicate the direction of data flow. One or more processor cores (such as the processor core 100) may be implemented on a single integrated circuit chip. Moreover, the chip may include one or more shared or private caches, interconnects, memory controllers, or the like.

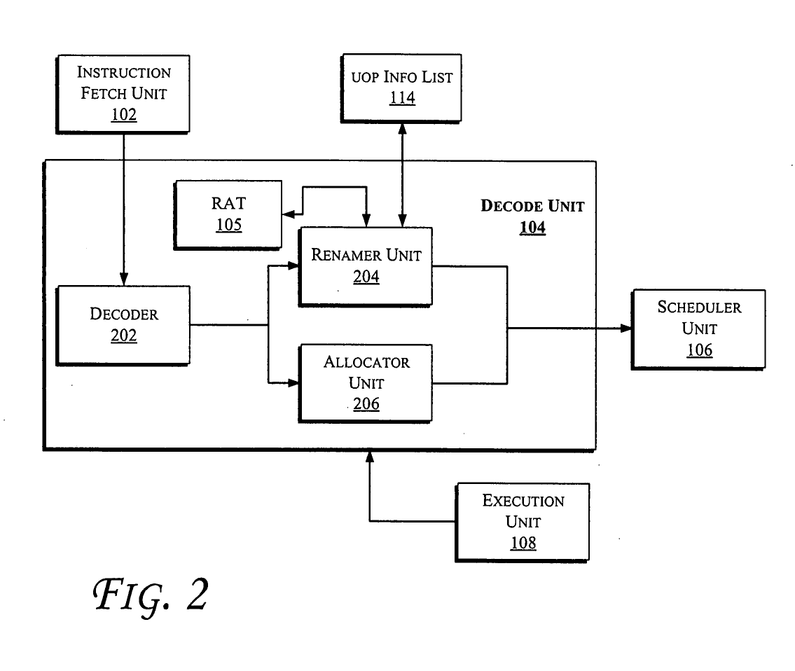

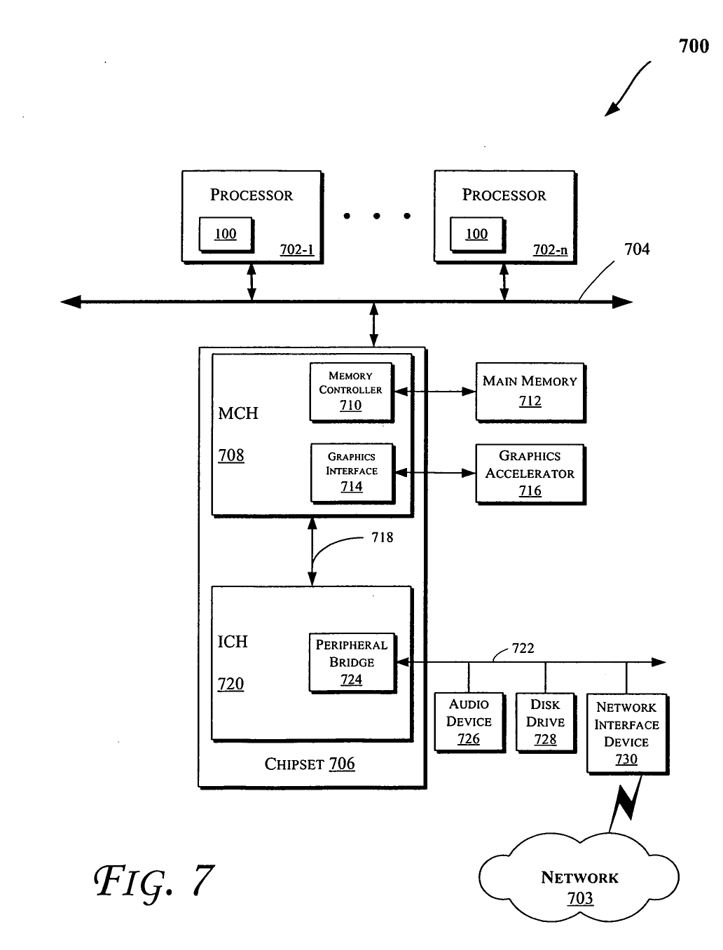

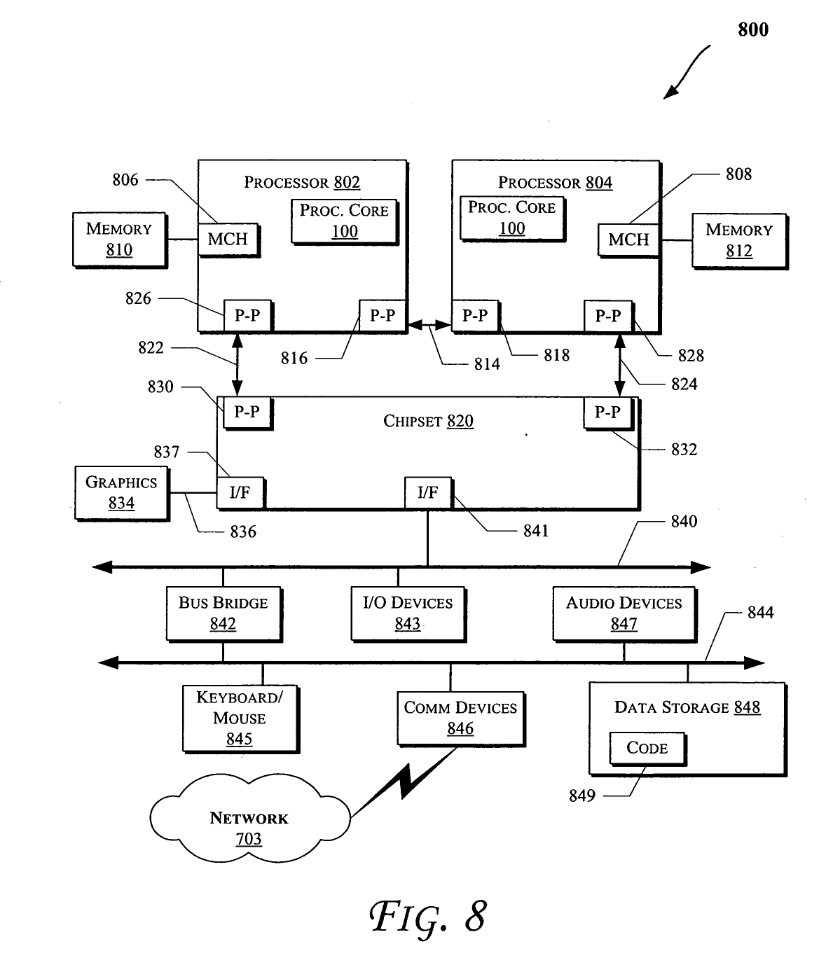

As illustrated in FIG. 1, the processor core 100 includes an instruction fetch unit 102 to fetch instructions for execution by the core 100. The instructions may be fetched from any suitable storage devices such as the memory devices discussed with reference to FIGS. 7 and 8. The instruction fetch unit 102 may be coupled to a decode unit 104 which decodes the fetched instruction and may determine instruction dependencies. The decode unit 104 may be coupled to a RAT (register alias table) 105 to maintain a mapping of logical (or architectural) registers (such as those identified by operands of software instructions) to corresponding physical registers. Further details regarding the operation of the decode unit 104 are discussed herein, e.g., with reference to FIGS. 2-6.

The decode unit 104 may be coupled to a scheduler unit 106 that may hold decoded instructions until they are ready for dispatch, e.g., until all source values (e.g., zero or more source values) of a decoded instruction become available. For example, with respect to an “add” instruction, the “add” instruction may be decoded by the decode unit 104 and the scheduler unit 106 may hold the decoded “add” instruction until the two values that are to be added become available. Hence, the scheduler unit 106 may schedule and/or issue decoded instructions to various components of the processor core 100 for execution, such as an execution unit 108. The execution unit 108 may execute the dispatched (also referred to as “issued”) instructions after they are decoded (e.g., by the decode unit 104) and dispatched (e.g., by the scheduler unit 106). In one embodiment, the execution unit 108 may include suitable execution units (not shown), such as a memory execution unit, an integer execution unit, a floating point execution unit, or the like. The execution unit 108 may be coupled to a retirement unit 110 to retire executed instructions in the original program order if the scheduler unit 106 issued the instructions for execution in a different order.

In an embodiment, the execution unit 108 may determine the occurrence of mispredictions (e.g., branch mispredictions) and communicate information regarding the mispredictions back to the decode unit 104, as will be further discussed with reference to FIG. 2. Furthermore, the retirement unit 110 may be coupled back to the scheduler unit 106 to provide data regarding committed instructions, e.g., when the scheduler unit 106 is waiting for data regarding committed instructions prior to dispatching a held instruction. Moreover, the execution unit 108 may be coupled back to the scheduler unit 106 to communicate data regarding executed instructions, e.g., to facilitate dispatch of dependent instructions. Hence, the scheduler unit 106 may be an out-of-order scheduler in one embodiment.

As shown in FIG. 1, the processor core 100 may also include a memory 112 to store instructions and/or data that are utilized by one or more components of the processor core 100. In an embodiment, the memory 112 may include one or more caches (that may be shared), such as a level 1 (L1) cache, a level 2 (L2) cache, or the like. Various components of the processor core 100 may be coupled to the memory 112 directly, through a bus, and/or memory controller or hub.

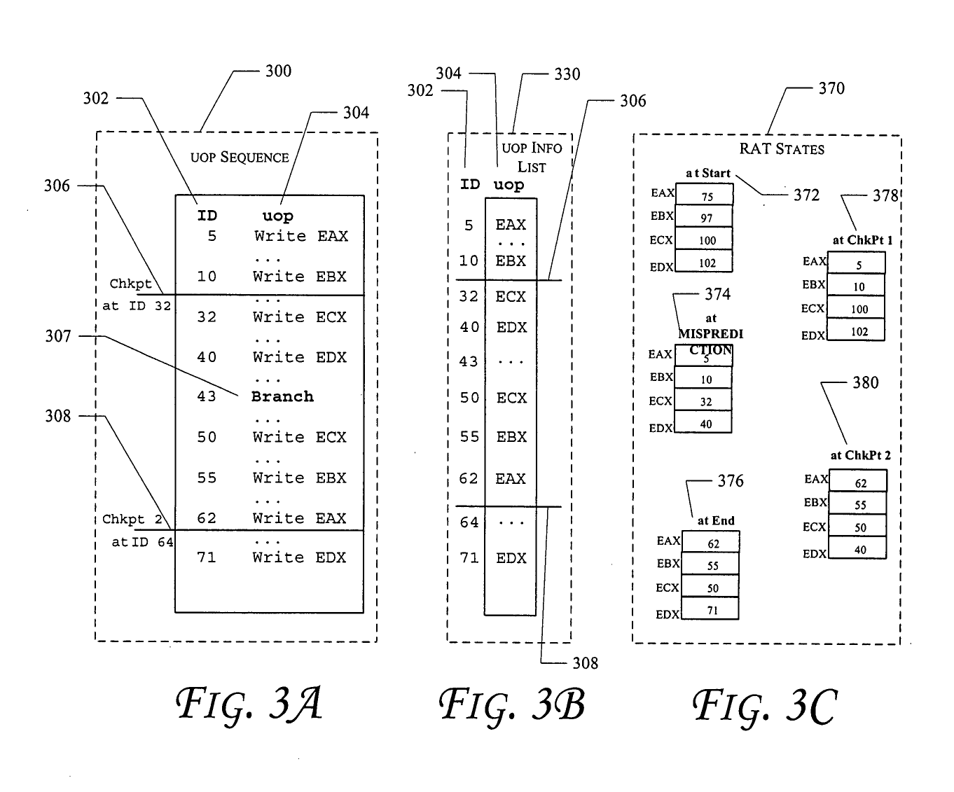

Also, the processor core 100 may include a uop information list 114 coupled to the decode unit 104 that may be utilized to recover the state of the RAT 105 upon occurrence of a misprediction, as will be further discussed herein, e.g., with reference to FIGS. 3-6. The processor core 100 may further include a reorder buffer (ROB)/Register File 116 to store information about in flight instructions (or uops) for access by various components of the processor core 100. In one embodiment, various components of the processor core 100 may be, but are not required to be, provided in the memory 112, such as the uop info list 114 and/or the RAT 105.

FIG. 2 illustrates a block diagram of an embodiment of a decode unit (104). In one embodiment, the arrows shown in FIG. 2 indicate the direction of data flow. The decode unit 104 may include a decoder 202 that receives fetched instructions from the instruction fetch unit 102 and decodes them, e.g., into one or more uops. The decoder 202 is coupled to a renamer unit 204 and an allocator unit 206. The renamer unit 204 may be coupled to the RAT 105, for example, to map logical (or architectural) registers (such as those identified by operands of software instructions) to corresponding physical registers. This may allow for dynamic expansion of general use registers to use available physical registers. As shown in FIG. 2, the RAT 105 may be implemented within the decode unit 104 in one embodiment, or elsewhere in the processor core 100 as discussed with reference to FIG. 1. The allocator unit 206 may assign resources to the uops so the uops can be executed (e.g., by the execution unit 108).

Additionally, the allocator unit 206 and/or the renamer unit 204 may be coupled to the execution unit 108 to receive information regarding mispredictions detected by the execution unit 108. As will be further discussed with reference to FIGS. 3-6, the renamer unit 204 may perform various operations (e.g., by utilizing data stored in the uop information list 114) to restore the state of the RAT 105 to the point of a misprediction, e.g., to allow new uops (from a correct path) to proceed in the processor core 100. In an embodiment, the renamer unit 204 and the allocator unit 206 may operate in parallel, so the renamer unit 204 works on the same uops to which the allocator unit 206 is assigning resources. Once the uops have completed the allocation (206) and rename process (204), they are passed to the scheduler unit 106 for dispatch.

Various operations associated with embodiments of the invention will now be further discussed with reference to FIGS. 3-8. These embodiments may be utilized to recover the state of the RAT 105 after a misprediction (e.g., a branch misprediction). FIG. 3A illustrates a sample sequence of uops 300 in program order and corresponding uop identifiers (which may be reorder buffer (ROB) (IDs) in an embodiment) 302 assigned to each uop (304), according to an embodiment. In one embodiment, the ROB/Register File 116 may be utilized to sequentially track uops that are decoded by the decode unit 104. In the example of FIG. 3A, two checkpoints (306 and 308) are taken, e.g., one at uop ID 32 (306) and another at uop ID 64 (308); however, any number of checkpoints may be taken at different locations in various embodiments (e.g., prior to or after uops). In one embodiment, multiple checkpoints of RAT (105) may be maintained. A checkpoint of the RAT is generally an entire copy of the RAT state at a given point in time. As shown in FIG. 3A, the checkpoint 306 may occur prior to the branch 307 (e.g., at uop ID 43) and the checkpoint 308 may occur after the branch 307. FIG. 3B illustrates a sample uop information list (330) which stores the logical destinations (304) and renamed physical addresses corresponding to each uop in the uop sequence (300), according to an embodiment. In one embodiment, the uop information list 330 illustrates sample values stored in the uop information list 114 of FIGS. 1 and 2. FIG. 3C illustrates embodiments of RAT states (370) at the start (372), at the branch (374), and at the end (376) of the uop sequence (300). Also shown in FIG. 3C are RAT states that are check-pointed in the first (378) and the second (380) checkpoints, which correspond to the checkpoints 306 and 308 of FIG. 3A in an embodiment. The RAT state at any point in the uop sequence can be derived by sequentially writing the ID of the uops into the RAT up to that point. For example, the RAT state at checkpoint 1 (378) can be derived by starting with the RAT state at the start (372) and writing the IDs 5 and 10 in locations EAX and EBX into the RAT, respectively.

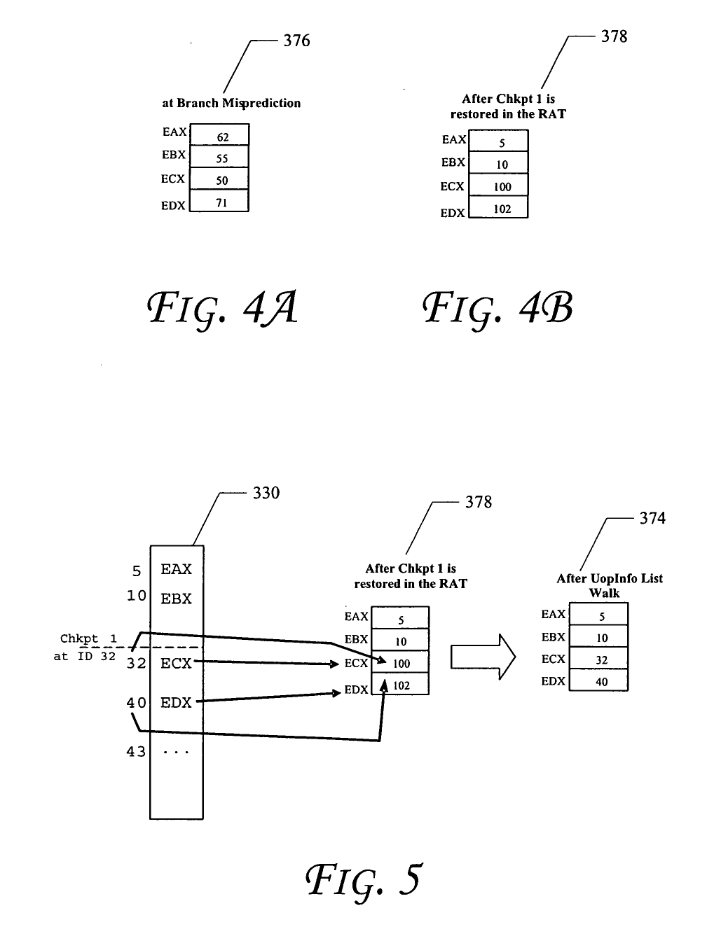

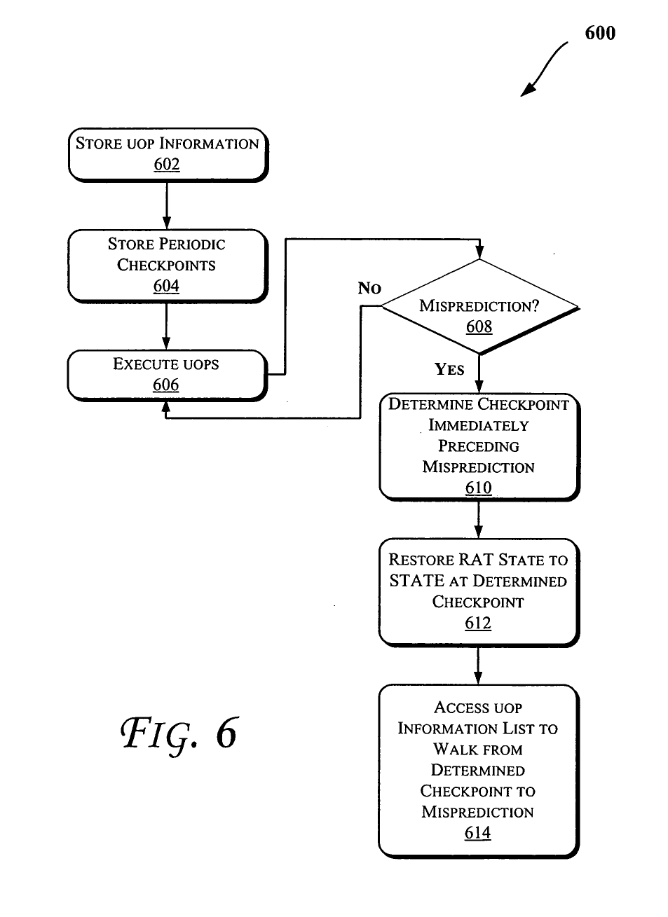

FIGS. 4A and 4B illustrate sample values at the time a misprediction (e.g., a branch misprediction) is detected and after an immediately preceding checkpoint is restored in the RAT, respectively, according to various embodiments. FIG. 5 illustrates sample values that may be utilized to restore the RAT, according to an embodiment. Further details regarding FIGS. 3-5 will be discussed with reference to the operations of FIG. 6.

FIG. 6 illustrates a flow diagram of an embodiment of a method 600 to provide early misprediction recovery through periodic checkpoints. In one embodiment, the operations of the method 600 may be performed by one or more of the components of a processor core, such as the components discussed with reference to FIGS. 1 and 2.

Referring to FIGS. 1-6, as uops are decoded (e.g., by the decode unit 104), for each uop, the renamer unit 204 stores (602) the logical destination, the physical destination, or other information (e.g., regarding registers) in the uop information list 114, such as discussed with reference to FIG. 3B. Hence, the uop information list (330) may include the logical destinations (304) and the corresponding uop IDs (302). The renamer unit 204 may also store checkpoints periodically (604) that correspond to states of the RAT 105. For example, at checkpoint 306, the state of the RAT 105 may be stored (378). In one embodiment, the operation 604 may be performed prior to, after, or in parallel with the operation 602. Also, in one embodiment, the checkpoints (e.g., 306 and 308) may be stored at regular or irregular intervals. Accordingly, the uop information list 114 may store the physical registers assigned to each uop that is in the machine (e.g., being processed by the processor core 100 of FIG. 1). The uop information list 114 may be written when a uop is allocated a physical register (e.g., by the allocator unit 206 of FIG. 2). The entry in the uop information list (114) is removed when the uop retires (e.g., by the retirement unit 110 of FIG. 1). The uop info list may be an array that is indexed by the uop sequence number or ID. Periodically (at regular or irregular intervals) the entire state of the RAT is saved (604) in a storage device (e.g., the memory 112 of FIG. 1). This is referred to herein as “checkpointing” the RAT. Since the entire RAT is saved, the storage required is usually substantial which may limit the number of such checkpoints of RAT at any given time. In the example illustrated in FIG. 3A, the ROB 116 of FIG. 1 may include 128 entries (e.g., indicating 128 uops in flight) and the RAT 105 may support 4 checkpoints. Hence, a checkpoint may be stored for every 32 uop entries. Also, the determined checkpoint may be within about 32 uop entries of the mispredicted branch.

At an operation 606, the execution unit 108 executes the uops. Once the execution unit 108 determines that a misprediction (e.g., a branch misprediction) has occurred (608), the execution unit 108 informs the decode unit 104 of the branch misprediction, such as discussed with reference to FIGS. 1-2. At an operation 610, the decode unit 104 (e.g., the renamer 204) determines the checkpoint that immediately precedes the mispredicted branch (e.g., checkpoint 306 immediately precedes branch 307 in uop sequence 300). As mentioned earlier, this mechanism for recovery can be used for restoring the RAT (105) state after any form of pipeline disruption. In that case, the decode unit 104 may be informed about the location of disruption by a unit (e.g., any suitable components of the processor core 100 of FIG. 1) that detected the disruption. Then, the decode unit 104 may proceed to restore the RAT (105) state as described herein.

At an operation 612, the decode unit 104 (e.g., the renamer 204) restores the RAT 105 to the state at the determined checkpoint (e.g., checkpoint 306 for this example). At an operation 614, the renamer 204 may access (e.g., read) one or more entries of the uop information list (e.g., 114 or 330) to update the state of the RAT 105, starting from an entry corresponding to the determined checkpoint (e.g., at uop ID 32) up to and including an entry corresponding to the misprediction (e.g., 307 at uop ID 43). In one embodiment, the renamer 204 sequentially accesses one or more entries of the uop information list (e.g., 114 or 330), for instance, to sequentially “walk” the RAT 105 to a state immediately following the uop which caused the misprediction, e.g. the mispredicted branch (307). For example, as illustrated in FIG. 5, information corresponding to the destination of the accessed entry (e.g., uop IDs) may be stored at a location in the RAT 105 that corresponds to a logical destination of the accessed entry. In an embodiment, since the scheduler unit 106 may operate out-of-order (as discussed with reference to FIG. 1), the detection of mispredictions and the recovery from them may also occur out-of-order. In one embodiment, the method 600 may recover one or more mispredictions that are younger than a misprediction that is being recovered or has already been recovered.

Referring to FIGS. 2, 5, and 6, the operation 614 (e.g., the renamer 204) reads the entry 32 from the uop information list (330), which indicates that the logical register written by that entry was ECX. Hence, the renamer 204 writes the physical destination assigned to the uop “32” in the RAT (105) entry for ECX. Next, the renamer 204 reads the entry 40 from the uop information list (330), which indicates that the logical register written by that entry was EDX. Hence, the renamer 204 writes “40” in the RAT (105) entry for EDX. This update ends when the branch entry (e.g., entry 307 of FIG. 3A) is reached and its physical destination has been updated in the RAT (105). At that point the RAT (105) state is what it was when the branch was renamed (e.g., changing from 376 of FIG. 4A to 378 of FIG. 4B).

In an embodiment, the recovery write operations (such as those discussed with reference to the operations 612 and/or 614) from the uop information list (114 of FIG. 1) use the existing ports to write into the RAT 105 as those used during the normal writes into the RAT 105 because following a mispredict the new uops from the correct path do not allocate (e.g., by the allocator unit 206 of FIG. 2 and write into the RAT 105) until the recovery is done. For example, if the RAT recovery occurs at the rate of 4 entries per cycle (assuming a 4 wide machine) and there are up to 32 entries to recover, then at most 8 cycles may be utilized to complete this recovery. Hence, many of these recovery cycles may be hidden behind the pipeline depth of the front-end part of the machine (e.g., the instruction fetch unit 102 of FIG. 1), because the new uops cannot arrive at the rename stage (at the renamer unit 204 of FIG. 2) prior to the number of cycles the new uops need to travel the front-end pipeline. Additionally, in an embodiment, the RAT recovery does not need to wait for branch retirement. Recovery can start as soon as the branch mispredicts.

FIG. 7 illustrates a block diagram of a computing system 700 in accordance with an embodiment of the invention. The computing system 700 may include one or more central processing unit(s) (CPUs) 702 or processors coupled to an interconnection network (or bus) 704. The processors (702) may be any suitable processor such as a general purpose processor, a network processor (that processes data communicated over a computer network 703), or the like (including a reduced instruction set computer (RISC) processor or a complex instruction set computer (CISC)). Moreover, the processors (702) may have a single or multiple core design. The processors (702) with a multiple core design may integrate different types of processor cores on the same integrated circuit (IC) die. Also, the processors (602) with a multiple core design may be implemented as symmetrical or asymmetrical multiprocessors. In an embodiment, one or more of the processors 702 may include one or more of the processor core 100 of FIG. 1. Also, the operations discussed with reference to FIGS. 1-6 may be performed by one or more components of the system 700.

A chipset 706 may also be coupled to the interconnection network 704. The chipset 706 may include a memory control hub (MCH) 708. The MCH 708 may include a memory controller 710 that is coupled to a memory 712. The memory 712 may store data and sequences of instructions that are executed by the CPU 702, or any other device included in the computing system 700. In one embodiment of the invention, the memory 712 may include one or more volatile storage (or memory) devices such as random access memory (RAM), dynamic RAM (DRAM), synchronous DRAM (SDRAM), static RAM (SRAM), or the like. Nonvolatile memory may also be utilized such as a hard disk. Additional devices may be coupled to the interconnection network 704, such as multiple CPUs and/or multiple system memories.

The MCH 708 may also include a graphics interface 714 coupled to a graphics accelerator 716. In one embodiment of the invention, the graphics interface 714 may be coupled to the graphics accelerator 716 via an accelerated graphics port (AGP). In an embodiment of the invention, a display (such as a flat panel display) may be coupled to the graphics interface 714 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 718 may couple the MCH 708 to an input/output control hub (ICH) 720. The ICH 720 may provide an interface to I/O devices coupled to the computing system 700. The ICH 720 may be coupled to a bus 722 through a peripheral bridge (or controller) 724, such as a peripheral component interconnect (PCI) bridge, a universal serial bus (USB) controller, or the like. The bridge 724 may provide a data path between the CPU 702 and peripheral devices. Other types of topologies may be utilized. Also, multiple buses may be coupled to the ICH 720, e.g., through multiple bridges or controllers. Moreover, other peripherals coupled to the ICH 720 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or the like.

The bus 722 may be coupled to an audio device 726, one or more disk drive(s) 728, and a network interface device 730 (which is coupled to the computer network 703). Other devices may be coupled to the bus 722. Also, various components (such as the network interface device 730) may be coupled to the MCH 708 in some embodiments of the invention. In addition, the processor 702 and the MCH 708 may be combined to form a single chip. Furthermore, the graphics accelerator 716 may be included within the MCH 708 in other embodiments of the invention.

Furthermore, the computing system 700 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 728), a floppy disk, a compact disk ROM (CD-ROM), a digital versatile disk (DVD), flash memory, a magneto-optical disk, or other types of nonvolatile machine-readable media suitable for storing electronic instructions and/or data.

FIG. 8 illustrates a computing system 800 that is arranged in a point-to-point (PtP) configuration, according to an embodiment of the invention. In particular, FIG. 8 shows a system where processors, memory, and input/output devices are interconnected by a number of point-to-point interfaces. The operations discussed with reference to FIGS. 1-6 may be performed by one or more components of the system 800.

As illustrated in FIG. 8, the system 800 may include several processors, of which only two, processors 802 and 804 are shown for clarity. The processors 802 and 804 may each include a local memory controller hub (MCH) 806 and 808 to couple with memories 810 and 812. The memories 810 and/or 812 may store various data such as those discussed with reference to the memories 112 and/or 712.

The processors 802 and 804 may be any suitable processor such as those discussed with reference to the processors 702 of FIG. 7. The processors 802 and 804 may exchange data via a point-to-point (PtP) interface 814 using PtP interface circuits 816 and 818, respectively. The processors 802 and 804 may each exchange data with a chipset 820 via individual PtP interfaces 822 and 824 using point to point interface circuits 826, 828, 830, and 832. The chipset 820 may also exchange data with a high-performance graphics circuit 834 via a high-performance graphics interface 836, using a PtP interface circuit 837.

At least one embodiment of the invention may be provided within the processors 802 and 804. For example, the processor core 100 of FIG. 1 may be located within the processors 802 and 804. Other embodiments of the invention, however, may exist in other circuits, logic units, or devices within the system 800 of FIG. 8. Furthermore, other embodiments of the invention may be distributed throughout several circuits, logic units, or devices illustrated in FIG. 8.

The chipset 820 may be coupled to a bus 840 using a PtP interface circuit 841. The bus 840 may have one or more devices coupled to it, such as a bus bridge 842 and I/O devices 843. Via a bus 844, the bus bridge 843 may be coupled to other devices such as a keyboard/mouse 845, communication devices 846 (such as modems, network interface devices, or the like that may be coupled to the computer network 703), audio I/O device, and/or a data storage device 848. The data storage device 848 may store code 849 that may be executed by the processors 802 and/or 804.

In various embodiments of the invention, the operations discussed herein, e.g., with reference to FIGS. 1-8, may be implemented as hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include any suitable storage device such as those discussed with respect to FIGS. 1, 7, and 8.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method comprising:
storing a plurality of periodic checkpoints corresponding to a plurality of states of a register alias table;
upon a misprediction, determining which one of the plurality of checkpoints immediately precedes the misprediction; and
accessing one or more entries of a uop information list from an entry corresponding to the determined checkpoint to an entry corresponding to the misprediction.

2. The method of claim 1, wherein accessing the one or more entries of the uop information list is performed sequentially.

3. The method of claim 1, wherein accessing the one or more entries of the uop information list comprises accessing the entry corresponding to the misprediction.

4. The method of claim 1, further comprising, for each uop information list entry that is accessed, storing information corresponding to a destination of the accessed entry of the register alias table at a location in the register alias table corresponding to a logical destination of the accessed entry.

5. The method of claim 4, wherein storing the information corresponding to the destination of the accessed entry comprises storing an identifier at the location in the register alias table corresponding to a logical destination of the accessed entry.

6. The method of claim 4, wherein storing the information updates a state of the register alias table.

7. The method of claim 4, wherein storing the information utilizes one or more of existing ports utilized to perform write operations on the register alias table.

8. The method of claim 1, wherein the periodic checkpoints are stored at regular or irregular intervals.

9. The method of claim 1, wherein the misprediction is one or more of a branch misprediction or a program execution disruption.

10. The method of claim 1, wherein one or more of a detection of the misprediction or a recovery from the misprediction occur out-of-order.

11. The method of claim 1, wherein the register alias table is restored to a state which is immediately prior to the misprediction without waiting for a retirement of a corresponding uop.

12. An apparatus comprising:
a renamer unit to:
store a plurality of periodic checkpoints corresponding to a plurality of states of a register alias table;
upon a misprediction, determine which one of the plurality of checkpoints immediately precedes the misprediction; and
access one or more entries of a uop information list from an entry corresponding to the determined checkpoint to an entry corresponding to the misprediction.

13. The apparatus of claim 12, further comprising an execution unit to determine an occurrence of the misprediction.

14. The apparatus of claim 12, wherein the misprediction is one or more of a branch misprediction or a program execution disruption.

15. The apparatus of claim 12, further comprising a processor core that comprises the renamer unit.

16. The apparatus of claim 15, further comprising a processor that comprises a plurality of the processor cores.

17. A processor comprising:
means for decoding instructions into a plurality of uops;
means for storing a plurality of periodic checkpoints corresponding to a plurality of states of a register alias table;
means for determining which one of the plurality of checkpoints immediately precedes a misprediction; and
means for accessing one or more entries of a uop information list from an entry corresponding to the determined checkpoint to an entry corresponding to the misprediction.

18. The processor claim 17, further comprising means for executing the uops.

19. A system comprising:
a memory to store a plurality of periodic checkpoints corresponding to a plurality of states of a register alias table; and
a renamer unit to access one or more entries of a uop information list to recover the register alias table to a state immediately preceding a misprediction.

20. The system of claim 19, further comprising an audio device.

21. The system of claim 19, wherein the memory is one or more of a RAM, DRAM, or SDRAM.

22. The system of claim 19, further comprising an execution unit to determine an occurrence of the misprediction.

23. The system of claim 19, further comprising a processor core that comprises the renamer unit.

24. The system of claim 23, further comprising a processor that comprises a plurality of the processor cores.

25. The system of claim 23, wherein the renamer accesses the uop information list from an entry corresponding to a checkpoint immediately preceding the misprediction to an entry corresponding to the misprediction.

26. The system of claim 19, wherein the misprediction is one or more of a branch misprediction or a program execution disruption.
